(19) United States
(12) Patent Application Publication
(10) Pub. No.: US 2026/0213617 A1
(43) Pub. Date: Jul. 23, 2026

(54) Method and apparatus of a juggernaut.

(71) Applicant: Christopher John Fritz, Reno, NV (US)

(72) Inventor: Christopher John Fritz, Reno, NV (US)

(21) Appl. No.: 19/031,831

(22) Filed: Jan. 18, 2025

(51) Int. Cl. H02K 7/18; H02K 7/075; H02K 7/09; H02K 7/102; H02K 7/116; H02K 53/00

(52) U.S. Cl. CPC H02K 7/1853; H02K 7/075; H02K 7/09; H02K 7/102; H02K 7/116; H02K 53/00

(57) ABSTRACT

A juggernaut method and apparatus utilizing power produced from a structure comprising a frame coupled to a crankshaft with a series of beams configured at different degrees of timing in rotational motion wherein when each beam is nearly vertical producing the linear displacement of a mass of matter, coupled to the beam, in the direction opposite the source of the force of gravity starting from a position with a less amount of potential energy and ending at a position with a greater amount of potential energy wherein the linear displacement is produced by means of the rotational motion momentum or inertia of the crankshaft impelling the interaction of a force, comprising electromagnetic fields, between a source coupled to the structure and or to each beam forevermore a percentage of the power derived from the kinetic energy of the crankshaft is utilized to produce a good and or a service.

### CROSS-REFERENCE TO RELATED APPLICATIONS

This application claims priority to provisional patent application U.S. Ser. No. 63/623211 (“The '211 application”) filed on Jan. 20, 2024; provisional patent application U.S. Ser. No. 63/556831 (“The '831 application”) filed on Feb. 22, 2024; provisional patent application U.S. Ser. No. 63/559,211 (“The '211 application”) filed on Feb. 29, 2024; provisional patent application U.S. Ser. No. 63/565,546 (“The '546 application”) filed on Mar. 15, 2024; provisional patent application U.S. Ser. No. 63/647,866 (“The '866 application”) filed on Jun. 9, 2024; provisional patent application U.S. Ser. No. 63/661,893 (“The '893 application”) filed on Jun. 20, 2024; provisional patent application U.S. Ser. No. 63/734,111 (“The '111 application”) filed on Dec. 15, 2024.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A READ-ONLY OPTICAL DISC, AS A TEXT FILE OR AN XML FILE VIA THE PATENT

Not applicable.

### STATEMENT REGARDING PRIOR DISCLOSURES BY THE INVENTOR OR A JOINT INVENTOR

A fraction of the application of this patent instrument incorporates material that is subject to (mask work or copyright) protection. The (mask work or copyright) proprietor has no protestation to the replication by any entity of the patent instrument or the patent material, as presented in the Patent and Trademark Office patent file or records, but anywise reserves all (mask work or copyright) rights whatsoever.

### BACKGROUND OF THE INVENTION

Juggernaut is a massive force which is impossible to stop.

Mechanics is the branch of mathematics and physics that comprises the effect of force and energy on a system.

Perpetual motion is a hypothetical system in continuous operation without the introduction of energy from an external source.

To the present date, no method and apparatus, or system, for perpetual motion is novel; moreover the ability to utilize mechanics from a perpetual motion system is unfounded.

### BRIEF SUMMARY OF THE INVENTION

A Juggernaut method and apparatus utilizing power produced from a structure comprising a frame coupled to a crankshaft with a series of beams configured at different degrees of timing in rotational motion wherein when each beam is nearly vertical producing the linear displacement of a mass of matter, coupled to the beam, in the direction opposite the source of the force of gravity starting from a position with a less amount of potential energy and ending at a position with a greater amount of potential energy wherein the linear displacement is produced by means of the rotational motion momentum or inertia of the crankshaft impelling the interaction of a force, comprising electromagnetic fields, between a source coupled to the structure and or to each beam forevermore a percentage of the power derived from the kinetic energy of the crankshaft is utilized to produce a good and or a service, comprising electricity.

### BRIEF DESCRIPTION OF THE SEVERAL VIEWS OF THE DRAWING(S)

The detailed description of some of the invention is made below with reference to the accompanying figures: one, two, three, four, five, six, seven, eight, nine, ten, eleven, and twelve.

FIG. 1 illustrates a balanced and unbalanced beam coupled to a fulcrum.

FIG. 2 illustrates the vector diagrams for a beam coupled to a fulcrum at 30 degrees and 345 degrees.

FIG. 3 illustrates numerous beams coupled to a structure and crankshaft configured at different degrees of timing in rotational motion designed with the likeness of a ferris wheel in a state of kinetic energy intrinsic via rotational motion momentum.

FIG. 4 illustrates the force of a union of sloped magnetic fields coupled to the structure and or frame wherein causing the displacement of a mass of matter coupled to a beam.

FIG. 5 illustrates the displacement of a mass of matter, coupled to a beam, opposite the force of gravity when the beam is in the nearly vertical position.

FIG. 6 illustrates the tandem coupling of the primary mass of matter to a secondary mass of matter by means of a primary and secondary linear actuator producing displacement from a nadir configuration of less potential energy to an acme configuration of greater potential energy.

FIG. 7 illustrates a series of linear actuators coupled to magnets producing the force of repulsion and utilizing a chain reaction producing displacement of the primary and secondary mass of matter, coupled to a beam, in a direction opposite the force of gravity.

FIG. 8 illustrates a primary series of magnets enclosed within a conduit wherein the mass of matter, coupled to a beam, in inherit in the magnets and coupled by the force of repulsion.

FIG. 9 illustrates, a cross section of a conduit wherein the displacement of the primary series of magnets coupled to the mass of matter is frictionless produced by the repulsion force between a secondary series of magnets coupled to the conduit and the primary series of magnets.

FIG. 10 table one illustrates the cosine values for the beams at numerous degrees of timing in rotation motion of the crankshaft coupled to the fulcrum utilized to determine the sum of the work of torque acting on the fulcrum.

FIG. 11 illustrates the locking mechanism wherein the displacement of the primary series of magnets is frictionless; the lock via magnetic repulsion and attraction holds the beam into the acme position when rotating about the fulcrum.

FIG. 12 illustrates a linear crankshaft as an alternate to the ferris wheel structure, applicable to when the displacement of the primary series of magnets is frictionless.

### DETAILED DESCRIPTION OF THE INVENTION

All definitions are comprising in nature. Sourcing materials, planning, construction, maintenance and repair of the apparatus is an intrinsic part of the method.

Scale of apparatus comprises a range from microscopic to macroscopic structures. Units to denote measurements may be interchanged comprising converting units such as meters to feet and so on.

Environment is the external factors influencing an area. Factors include gravity, viscosity of the molecules in the space around the structure and or frame, and influences creating decay comprising solar radiation.

Mass is the property of an object with respect to its amount of matter, its influence within a gravitational field, and its inherit inertia.

Velocity is an object's speed and direction of movement.

Acceleration is the rate at which an object changes its magnitude of velocity.

Displacement is the change of position of an object with a correlated measurement. Displacement can be the direction opposite the source of the force of gravity and may include being synonymous with lift.

Height is the distance an object is above a reference point comprising the ground. Elevation and or altitude is the height of an object above sea level and or ground level.

Rotation is the turning motion about a fixed point or axis.

Momentum is an object's mass, speed, and direction. Momentum (p) is the mass (m) and velocity (v) of an object denoted by the formula p=mv. Momentum is a vector quantity.

Inertia is the ability of an object to resist a change in its state of motion, rest or movement, comprising magnitude and direction.

To transmit is the transfer of energy, motion, or force from one object to another object comprising objects of a machine and or a system.

An actuator is a mover such as a hydraulic cylinder and or pneumatic cylinder.

Force is commonly paraphrased as push or pull. Force is an influence resulting in the modification of an object's movement. Force is a vector quality thus it has both magnitude and direction. Paraphrasing Newton's third law of motion for every action there is an equal and opposite reaction. The formula for force is given by Force (F)=Mass (m)*Acceleration (a). F=ma.

Work is the sum of all force applied to an object or system from a starting point to an end point. Work is a scalar quality, thus it has magnitude but no direction. Work is a universal way to explain the amount of effort needed to complete a task involving different forms of effort and the different directions and distances the forms were applied to an object or system. Work is the force multiplied by the displacement. W=FΔd.

Power is the rate of energy transfer with time or the amount of work in a given time. Power is equal to work divided by the elapsed time that the work is done. P=W/Δt.

The work required to produce displacement of an object linearly in a direction opposite the source of the force gravity (earth), or lift, is denoted by the formula work (W) equals (=) mass in kilograms (kg) multiplied by 9.8 meters per second (m/s) multiplied by the displacement (Δx) in the direction opposite the force of gravity in meters.

Torque is the amount of force required to be applied to cause rotation of an structure or beam about a fulcrum or the amount of force required for an structure to resist rotation about a fulcrum. Torque(τ) is denoted by the formula t=r*F where r is the distance from the fulcrum to the application of the force on a beam and F is the force applied perpendicular to the line from the fulcrum to where the force is applied like a lever.

The work required to rotate an object about a fulcrum is denoted by the formula Work (W)=Torque(τ) multiplied by the angle of rotation (θ) in radians.

Radians, there are 6.28 radians per 360 degrees of rotation.

A Lever is an object or beam with one point on an fulcrum and a force applied to a second point on the beam some distance from the fulcrum causing rotation of the beam about the fulcrum. The fulcrum is synonymous with a crankshaft and the beam with a crank.

The fulcrum is the axis or pivot about which a structure comprising a lever and or beam rotates. The lexicon of the fulcrum is interchangeable with crankshaft.

A crank is a lever attached to a shaft wherein motion is transferred from the crank to the shaft or vice versa. Crankshaft is a crank connected to a shaft wherein the application of force to the crank causes rotation of the shaft by transfer of force. A crank may be a beam coupled to the crankshaft wherein nearly the center of the beam attaches to the crankshaft wherein the crankshaft then becomes the fulcrum of the beam.

An unbalanced beam or cantilever is a projecting object supported at one end, such as a lever. For the purposes of this invention it may also include an unbalanced amount of mass on two levers, two cranks or a beam positioned on a parallel plane running through the fulcrum and or the crankshaft.

The fundamental forces of nature are a weak nuclear force, a strong nuclear force, an electromagnetic force, and a gravitational force. Gravitational force is a physical force of attraction between one mass and at least one other mass, wherein mass may be an aggregate of matter. Gravitational force and electromagnetic force, or fields, can act upon an object or system from a significant distance, thus is described as a non-contact force. The gravitational force between two objects is equal to multiplying their mass together then dividing by the distance between the centers of their mass and then multiplied by the constant of universal gravitation 6.674 multiplied by 10\hat{ }-11 N*m/kg\hat{ }2. Gravitational force is an attractive force only. Earths constant for the acceleration of gravity is equal to 9.8 m/s. Normal force has the same magnitude as gravitational force but is opposite in direction to gravitational force.

Non-conservative force dissipates as heat, sound, or light instead of being transferred completely to the object in which the force is acting upon. Conservative force is transferred completely. Elastic collisions conserve both momentum and kinetic energy. Inelastic collisions conserve momentum but decrease kinetic energy. In perfectly inelastic collisions one object sticks to the other.

Kinetic energy is the energy an object possesses due to the motion of said object. Kinetic energy is a scalar quality. Potential energy is the energy an object possesses due to its position.

The change in kinetic energy is the sum of conservative work and non-conservative work.

The work energy theorem can be expressed as the sum of the final kinetic energy plus the final potential energy minus the initial kinetic energy plus the initial potential energy.

Work is measured in Joules. Power is measured in watts. One Joule is equal to 0.0002777778 watt hours or 0.0000002777 kilowatt hours abbreviated kWh.

Energy is the change in work on a body or system measured in Joules.

Magnetic fields are the area around a magnetized object where the influence of the magnetic force can be detected.

A magnet is an object that attracts ferrous materials and other magnets as well as repels other magnets. Magnets comprise permanent and or electromagnetic.

Magnetic poles are one of two points where the magnetic force is concentrated. Magnets have a north pole and a south pole. Like or equivalent magnetic poles, such as south (S) and south (S), repel and opposite magnetic poles attract, such as north (N) and south (S).

The magnetic force of attraction of two opposite poles of at least two magnets and or between at least one magnet and at least one ferrous material pulls them closer together in position. The magnetic force of repulsion between two like poles of at least two magnets push the magnets farther away in position from each other.

The magnets may be replaced and or magnetized to increase the gauss of the magnet as needed.

A circuit is the route wherein an electrical current may flow.

Induction is the production of electrical flow within a circuit with the introduction of a magnetic field within proximity to the electrical circuit.

A switch is a electronic or mechanical device to open or close an electrical circuit.

A solenoid is a coil of wire wherein an electrical current is switched on or off to open or close a mechanical gate or valve.

A case or conduit is the outermost cover and or housing that delineates the outside from the inside of a system and or object. The case may be perforated with numerous ports comprising airlocks and or sealed to provide an airtight enclosure comprising sustaining a vacuum. A vacuum reduces and or eliminates the resistance, aerodynamic drag and or friction to the movement of a structure. An inside of the case may be filled with compounds of low viscus materials comprising helium to reduce the resistance or friction to the movement of the crankshaft. The case may also house a container to collect lubrication that has been coupled to the frame and moving objects.

An engine is a machine and or system that converts energy to mechanical motion comprising linear and or rotational motion.

A structure and or frame is an object which provides structural support with the ability to transfer static and dynamic loads into a foundation and or throughout its structure.

A mount is an object utilized to secure one object to another object.

A fastener is an object utilized to join at least two objects together firmly by means of a mount.

A keeper is an object for stabilizing another object in a wanted and or determined position.

A bearing is an object that provides support for the linear or rotational movement of an object in a machine to reduce vibration and friction and or the amount of non-conservative force loss. A bearing commonly supports a crankshaft. Bearings may be contact, non-contact, or any combination thereof. A non-contact bearing is magnetic in nature and may employ a fluid medium as a lubricant to reduce the coefficient of friction and or drag.

Lubricant is a substance utilized to reduce friction between at least two objects commonly utilized by a contact bearing to reduce the coefficient of friction.

A coupler is an object of which joins two objects together.

A brake is an object that slows down or stops another object from linear or rotational motion.

A lock is an object to fix or unfix an object into a specific position.

A gear is an object of which transmits motion from one object to at least one other object comprising by rotation and or linear displacement. Gears coupled to a crankshaft and a transmission to utilize the rotational movement of the crankshaft.

Gears coupled to a track utilize rotational movement to displace along a track in linear movement.

A transmission is an object comprising numerous gears and shafts to transmit power from an engine to an end function such as mechanical motion comprising linear and or rotational motion.

A linear actuator produces linear motion utilizing inputs comprising electricity, mechanical motion, and or fluid mediums such as hydraulics and or pneumatics utilized by an apparatus. A linear actuator extends and retracts a cylinder rod from a sleeve with an input comprising pneumatics and or hydraulics and or a fluid medium.

A rod is an elongated cylindrical object.

A sleeve is a tube shaped object to fit over a rod.

A cap is the top part of an object.

A base is the bottom part of an object.

A tube is a cylinder with a hollow interior for transferring a fluid medium.

A fluid is a substance or medium whose molecules flow freely as in a liquid and or a gas.

A valve is an object that controls the flow of a fluid medium through a tube.

A cam is an irregular shaped projection on a crankshaft which transforms rotational motion movement into linear reciprocating movement.

A camshaft is a shaft being separate but coupled to a crankshaft with numerous cams wherein its mechanical means is to transform rotational motion into linear displacement.

Configuration is the way the parts of an object are arraigned.

Series are numerous similar individual objects and or elements sequentially configured.

The term unbalanced load or beam is interchangeable with a mass of matter comprising potential energy and or kinetic energy with an intrinsic moment of force comprising momentum and or inertia.

Alignment is a linear configuration. Radiate is a configuration spread out from a central point.

Cosine is a trigonometric function of a right triangle proportional to the length of the adjacent side of the angle of the triangle divided by the length of the hypotenuse side of the angle of the triangle.

Polar coordinates are a two dimensional coordinate system wherein a point on the plane is determined by the distance from a reference point and angle from a reference direction.

Euclidean space is a plotting system in three dimensional space comprising the x-axis, a y-axis, and a z-axis.

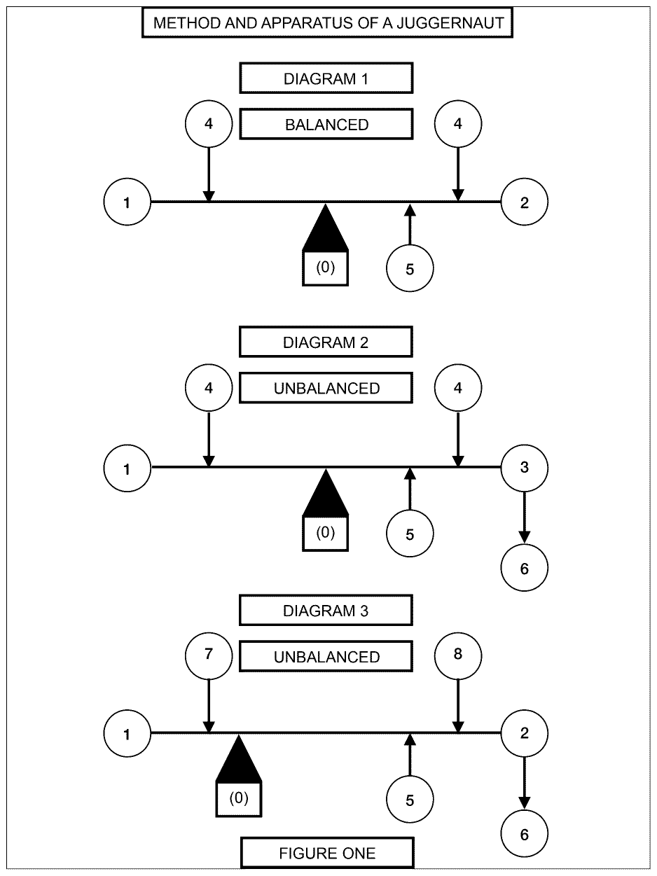

FIG. 1: illustrates a balanced and unbalanced beam coupled to a fulcrum. Diagram 1 illustrates a balanced beam (5), or two coupled levers, coupled to a fulcrum (0) with two equal masses of matter denoted as a primary mass of matter (1) and a secondary mass of matter (2) wherein the primary mass of matter and the secondary mass of matter are equal in mass and positioned on the beam (5) at an equal distance (4) from the fulcrum (0); diagram 2 is an unbalanced beam (5) coupled to the fulcrum (0) comprising a primary mass of matter (1) being less in mass than a tertiary mass of matter (3) wherein the primary mass of matter (1) and the tertiary mass of matter (3) are an equal distance (4) from the fulcrum (0) producing torque from the heavier tertiary mass of matter (3) on the fulcrum (0) in the direction (6) towards the source of gravity. Diagram 3 is an unbalanced beam (5) coupled to the fulcrum (0) comprising a primary mass of matter (1) equal in mass to a secondary mass of matter (2) wherein the distance (7) from the primary mass of matter (1) to the fulcrum (0) contrasts an unequal distance (8) from the secondary mass of matter (2) to the fulcrum (0) producing torque from the longer lever coupled to the secondary mass of matter (2) on the fulcrum (0) in the direction (6) towards the source of gravity. An unbalanced beam that is static increases the potential energy to produce torque on the lever of a fulcrum and or crankshaft. An unbalanced beam that is in motion increases the kinetic energy of the rotational motion momentum or inertia of the lever about the fulcrum and or crankshaft.

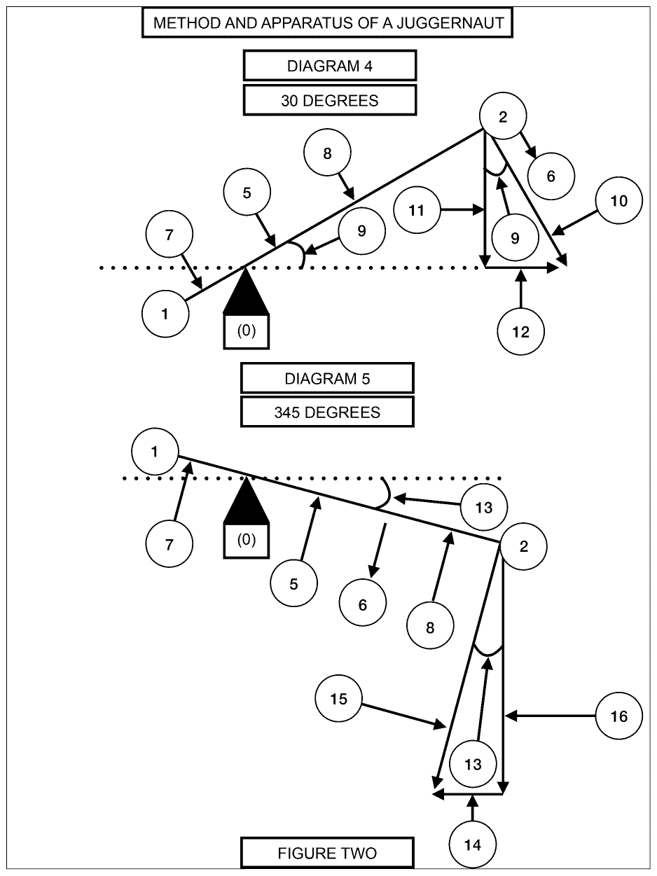

FIG. 2: illustrates the vector diagrams for a beam coupled to a fulcrum at 30 degrees and 345 degrees. In vector diagrams the length of the side of the triangle can be proportional to the force vector. Diagram 4 illustrates the example from figure one diagram 3 wherein additionally denoted is the graph of a vector diagram of the torque produced by the secondary mass of matter (2) coupled to the fulcrum (0) by a beam (5) at an angle (9) of 30 degrees from a horizontal axis or level. The secondary mass of matter (2) produces a force of torque (10) on the fulcrum (0) in a direction towards the source of the force of gravity denoted by vector (11) in a magnitude determined by the trigonometric function of the cosine of the angle (9) multiplied by the secondary mass of matter (2) in kilograms multiplied by the constant of the acceleration of gravity on Earth at 9.8 meters per second and producing either an increase in kinetic energy of the rotation in a clockwise direction (6) of the beam (5) about the fulcrum (0) or an increase in potential energy in a static beam (5). Diagram 5 illustrates the example from figure one diagram 3 wherein additionally denoted is the graph of a vector diagram of the torque produced by the secondary mass of matter (2) coupled to the fulcrum (0) by a beam (5) at an angle (13) of 345 degrees from a horizontal axis or level. The secondary mass of matter (2) produces a force of torque (15) on the fulcrum (0) in a direction towards the source of the force of gravity denoted by vector (16) in a magnitude determined by the trigonometric function of the cosine of the angle (9) multiplied by the secondary mass of matter (2) in kilograms multiplied by the constant of the acceleration of gravity on Earth at 9.8 meters per second and producing either an increase in kinetic energy of the rotation of the crankshaft (0) in a clockwise direction (6) of the beam (5) about the fulcrum (0) or an increase in potential energy of a static beam (5).

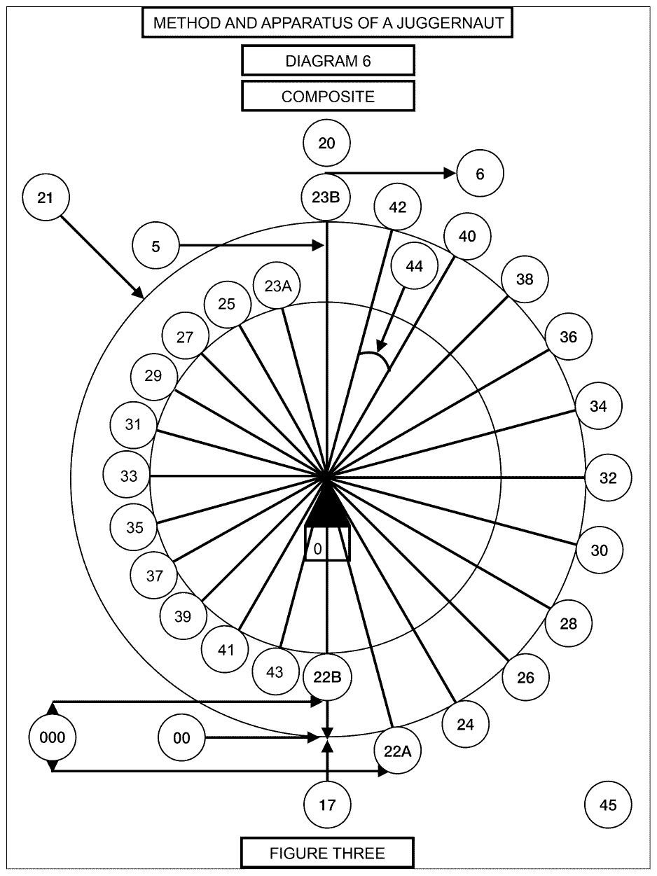

FIG. 3; illustrates numerous beams (5) coupled to a structure (45) and or frame designed with the likeness of a ferris wheel structure (21). Diagram 6 illustrates the example from figure one diagram 3 and the example from figure five diagram 8 and 9 wherein additionally denoted is a composite of numerous unbalanced beams (5) coupled to the fulcrum (0) at different degrees of timing in rotational motion producing a ferris wheel structure (21) coupled to the structure and or frame (45). The unbalanced beam (5) comprising the secondary mass of matter (2) coupled to a quaternary magnet (18) (22A as illustrated in figure five diagram 8) and the primary mass of matter (1) coupled to a tertiary magnet (19) (23A as illustrated in figure five diagram 8) is in the nadir position (22A and 23A as illustrated in figure five diagram 8) rotating in the clockwise direction (6) impelled by the momentum and or inertia of the rotational motion of the crankshaft (0), produced by the sum of the torque produced by the masses of matter (42, 40, 38, 36, 34, 32, 30, 28, 26, 24, 22A) coupled to its respective beam (5) and the crankshaft (0) causing 22a to rotate and enter the force of repulsion (00) between the magnetic field of the secondary magnet (17) and the quaternary magnet (18) coupled to the secondary mass of matter (2) (22 as illustrated in figure four diagram 7) wherein producing displacement of the mass of matter, for a distance of displacement (000), in the direction opposite the source of gravity thus proceeding into the acme position (22B and 23B as illustrated in figure five diagram 9). Moreover figure three illustrates numerous beams (5) coupled to the fulcrum (0) being separated by an equidistant angle (44) of 15 degrees between each beam in the timing of the rotational motion of the beams (5) about the fulcrum (0) or crankshaft.

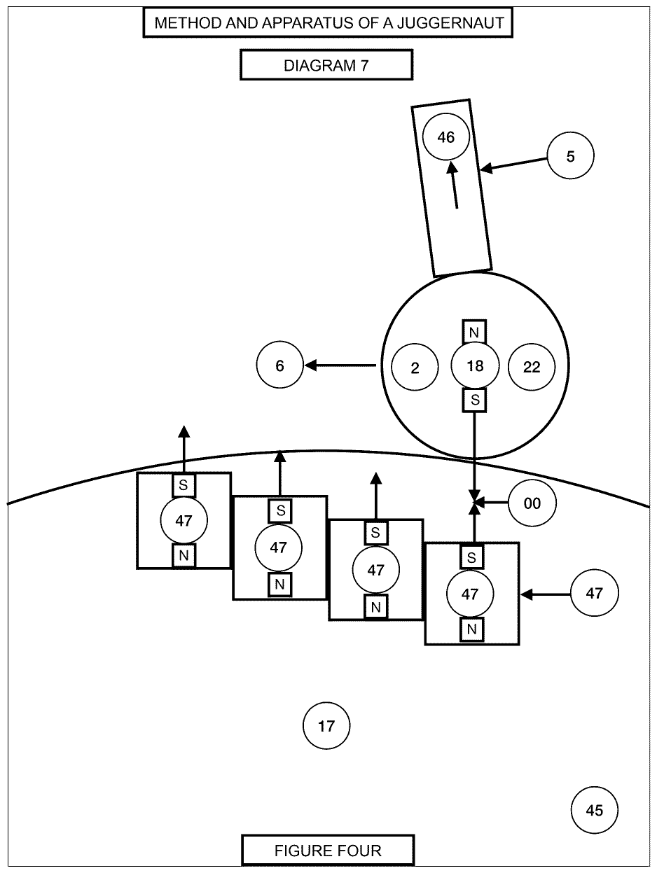

FIG. 4: illustrates the force of a union of sloped magnetic fields coupled to the structure and or frame wherein causing the displacement of the mass of matter coupled to the beam in the direction opposite the force of gravity. Diagram 7 illustrates the example from figure one diagram 3 wherein additional denoted is a beam (5) coupled to the secondary mass of matter (2) and quaternary magnet (18) represented by the composite structure (22) oriented with its magnetic south pole facing towards the source of the force of gravity and the beam (5) is rotating in a clockwise direction (6) impelled by the rotational motion momentum or inertia of the crankshaft (0) coupled to numerous beams (5) entering into the force of repulsion (00) of a union of magnets (47) with their magnetic south poles oriented facing away from the source of the force of gravity and in a lay out of a stepwise series configuration and coupled to the frame (45) and represented as a whole as the secondary magnet (17) wherein producing the force of repulsion (00) for the means to displace the composite structure (22) in the direction (46) nearly opposite the source of the force of gravity. The stepwise series configuration of the union of magnets (47) may also be a configuration of a sloped series of magnets.

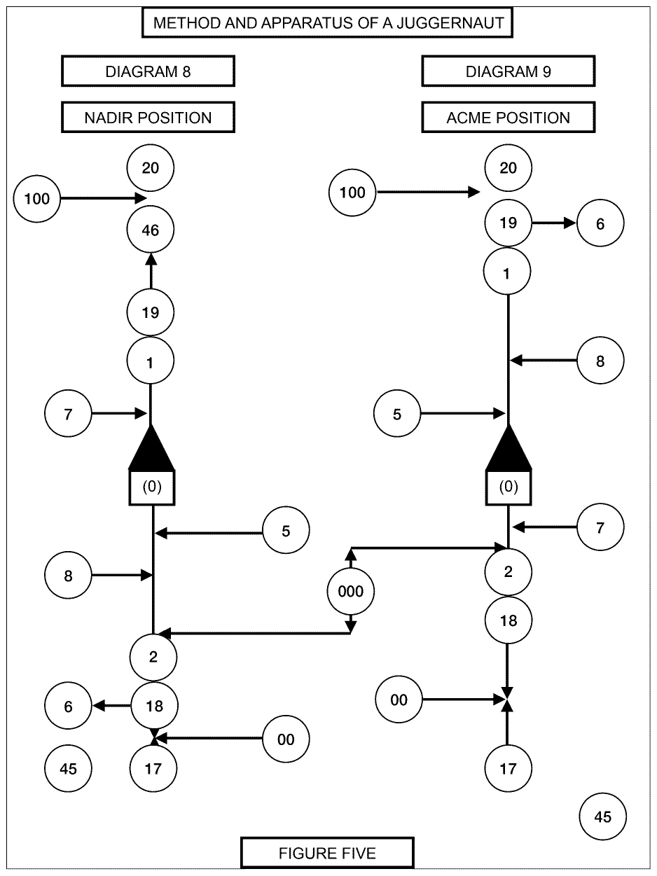

FIG. 5: illustrates the displacement of a mass of matter coupled to a beam opposite the source of the force of gravity in a nearly vertical position. Diagram 8 illustrates the example from figure one diagram 3 and figure three diagram 6 wherein additionally denoted is a beam (5) aligned nearly vertical in the nadir position preceding diagram 9 prior to the displacement of the mass of matter, for a distance of displacement (000), in the direction (46) opposite the source of the force of gravity. In the example of figure three diagram 6 the beam (5) comprising the secondary mass of matter (2) coupled to a quaternary magnet (18) equivalent to (22A) and the primary mass of matter (1) coupled to a tertiary magnet (19) equivalent to (23A) is synonymous with figure five diagram 8 illustrating the nadir position of the beam (5). In the example of figure three diagram 6 the beam (5) comprising the secondary mass of matter (2) coupled to a quaternary magnet (18) equivalent to (22B) and the primary mass of matter (1) coupled to a tertiary magnet (19) equivalent to (23B) is synonymous with figure five diagram 9 illustrating the acme position of the beam (5). Displacement of the tandem mass of matter, comprising the primary mass of matter (1) coupled to the secondary mass of matter (2), for a distance of displacement (000), in the direction (46) opposite the source of the force of gravity is produced by means of the rotational motion (6) momentum or inertia derived from the sum of the torque produced by the numerous unbalanced beams (5) as illustrated in FIG. 3 diagram 6 coupled to the crankshaft (0) impelling the interaction of the magnetic force of repulsion (00) via like magnetic poles between the secondary magnet (17) and the quaternary magnet (18) when in proximity wherein thereafter the beam locks in place until the same beam (5) rotates 180 degrees and unlocks repeating the above process between the secondary magnet (17) and the tertiary magnet (19). The beam may lock and or unlock at any time anywise as needed. The potential energy of the mass of matter coupled to the beam in the acme position is converted into kinetic energy by the rotational motion (6) inertia or momentum of the crankshaft coupled to the beams (5). The process repeats continuously until either stopped by a brake and or mechanical failure. Moreover the option to include a primary magnet (20) and or an object of ferrous material (20) to produce the magnetic force of attraction (100) with the tertiary magnet (19) and quaternary magnet (18).

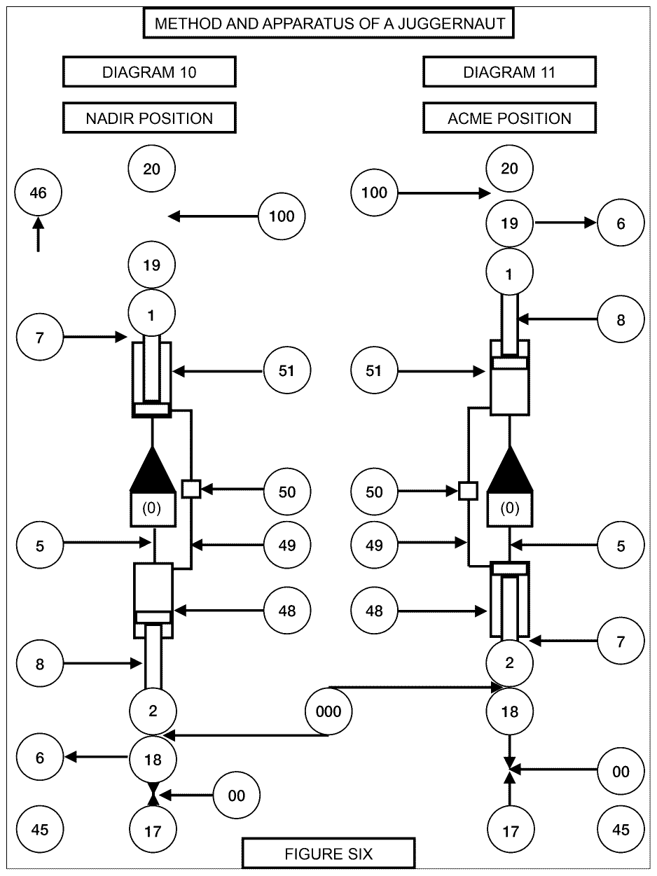

FIG. 6: illustrates the tandem coupling of the primary mass of matter to a secondary mass of matter by means of a primary and secondary linear actuator transmitting the displacement of the mass of matter from a nadir position of less potential energy to an acme position of greater potential energy. Diagram 10 and diagram 11 illustrates the example from figure one diagram 3 wherein additionally denoted is the alignment of a primary linear actuator (48) coupled by a hollow tube (49) with an open valve (50) to a secondary linear actuator (51) wherein producing operation in tandem the displacement of the primary mass of matter (1) coupled to the primary linear actuator (48) and the secondary mass of matter (2) coupled to the secondary linear actuator (51) in the direction (46) nearly opposite the source of the force of gravity produced by the magnetic force of repulsion (00) between the secondary magnet (17) and the quaternary magnet (18) producing retraction of the cylinder of the primary linear actuator (48) expelling a fluid medium to transmit across the fulcrum (0) by the hollow tube (49) to the secondary linear actuator (51) producing extension of the cylinder of the secondary linear actuator (51). The secondary magnet (17) is also illustrated in figure four diagram 7 wherein comprising the magnetic force of repulsion (00) originating from a union of magnets (47) configured in a sloping series. Figure six diagram 10 illustrates the unbalanced beam (5) in the nadir position preceding the retraction of the cylinder on linear actuator (48) and the extension of the cylinder on linear actuator (51) is synonymous with figure six diagram 10 illustrating the nadir position of the beam (5) comprising less potential energy. In the example of figure three diagram 6 the beam (5) comprising the secondary mass of matter (2) coupled to a quaternary magnet (18) equivalent to (22A) and the primary mass of matter (1) coupled to a tertiary magnet (19) equivalent to (23A) is synonymous with figure six diagram 10 illustrating the nadir position of the beam (5) comprising less potential energy. In the example of figure three diagram 6 the beam (5) comprising the secondary mass of matter (2) coupled to a quaternary magnet (18) equivalent to (22B) and the primary mass of matter (1) coupled to a tertiary magnet (19) equivalent to (23B) is synonymous with figure six diagram 11 illustrating the acme position of the beam (5) comprising more potential energy. Displacement of the tandem mass of matter, comprising the primary mass of matter (1) coupled to the secondary mass of matter (2), for a distance of displacement (000), in the direction (46) opposite the source of the force of gravity is produced by means of the rotational motion (6) momentum or inertia derived from the sum of the torque produced by the numerous unbalanced beams (5) coupled to the crankshaft (0), as illustrated in figure three diagram 6, impelling the interaction of the magnetic force of repulsion (00) via like magnetic poles between the secondary magnet (17) and the quaternary magnet (18) when in proximity wherein thereafter valve (50) closes locking the linear actuators in place until the same beam (5) rotates 180 degrees and valve (5) opens unlocking the linear actuators repeating the above process utilizing the secondary magnet (17) and the tertiary magnet (19). The potential energy of the mass of matter coupled to the beam in the acme position is converted into kinetic energy by the rotational motion (6) inertia or momentum of the crankshaft coupled to the beams (5).

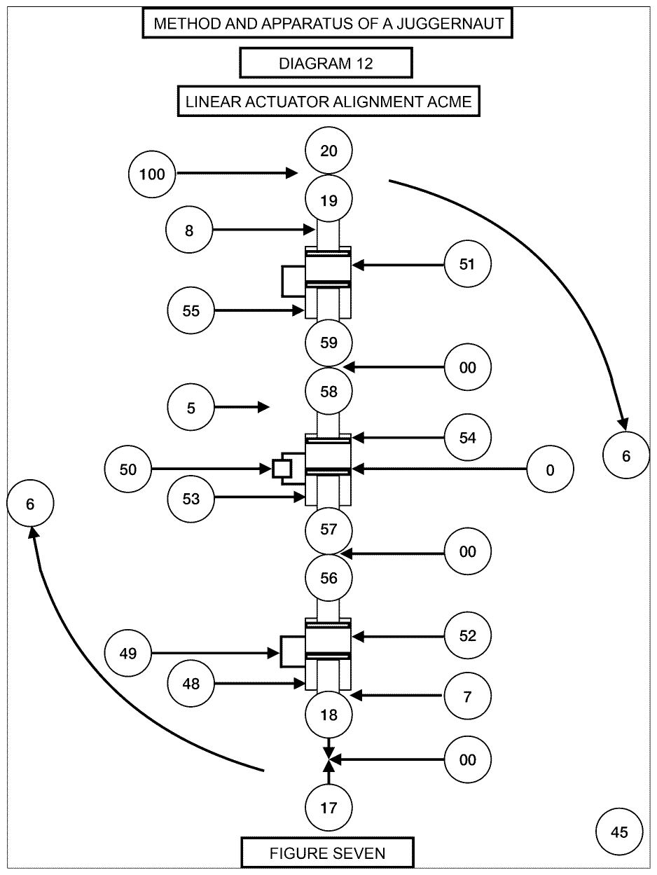

FIG. 7: illustrates a series of linear actuators utilizing a chain reaction transmitting the displacement of the tandem coupling the primary mass of matter (1) and the secondary mass of matter (2) coupled to the beam (5) in the direction opposite the source of the force of gravity. Diagram 12 illustrates the example from figure one diagram 3, figure five diagram 9, and figure six diagram 11 wherein additionally denoted is the alignment of numerous linear actuators to transmit, the displacement of the tandem mass of matter, comprising the primary mass of matter (1) coupled to the secondary mass of matter (2), for a distance of displacement (000), in the direction opposite the source of the force of gravity whereby produced by means of the rotational motion (6) momentum or inertia derived from the sum of the torque produced by the numerous unbalanced beams (5) coupled to the crankshaft (0) impelling the interaction of the magnetic force of repulsion (00) via like magnetic poles between the secondary magnet (17) and the quaternary magnet (18) when in proximity wherein thereafter the linear actuators and their respective cylinder rods lock in place until the same beam (5) rotates 180 degrees and unlocks repeating the above process utilizing the secondary magnet (17) and the tertiary magnet (19). The displacement via the magnetic force of repulsion (00) between the primary mass of matter coupled to the quaternary magnet (18) and the secondary magnet (17) produces a chain reaction displacing the quaternary magnet (18) coupled to the ultimate linear actuator (48) producing retraction of the cylinder rod expelling a fluid medium by way of a hollow tube (49) and coupled to the sub-ultimate linear actuator (52) producing the extension its respective cylinder rod coupled to the octonary magnet (56) wherein the magnetic force of repulsion (00) displaces the septenary magnet (57) producing retraction of the cylinder of the intermediate ultimate linear actuator (53) wherein expelling a fluid medium by way of a hollow tube (49) coupled to the intermediate primary linear actuator (54) producing extension of its respective cylinder rod coupled to the senary magnet (58) producing the magnetic force of repulsion (00) to displace the quinary magnet (59) producing retraction of its respective cylinder rod to the subprime linear actuator (55) wherein expelling a fluid medium by way of a hollow tube (49) coupled to the primary linear actuator (51) producing extension of tis respective cylinder rod coupled to the tertiary magnet (19) then locking all the linear actuators and there respective cylinder rods in place by closing valve (50) on the hollow tube (49) thus increasing the potential energy wherein transforming into kinetic energy impelled by means of the rotational motion (6) momentum or inertia derived from the sum of the torque produced by the numerous unbalanced beams (5) coupled to the crankshaft (0), as illustrated in figure three diagram 6. The chain reaction may also comprise but is not limited to the magnetic force of attraction (100) between the tertiary magnet (19) and or a ferrous material (19) and the primary magnet (20) and or a ferrous material (20). The chain reaction may also comprise utilizing both the magnetic force of repulsion (00) and the magnetic force of attraction (100) via comprising like magnetic poles, opposite magnetic poles and or the attraction of a magnet and a ferrous material.

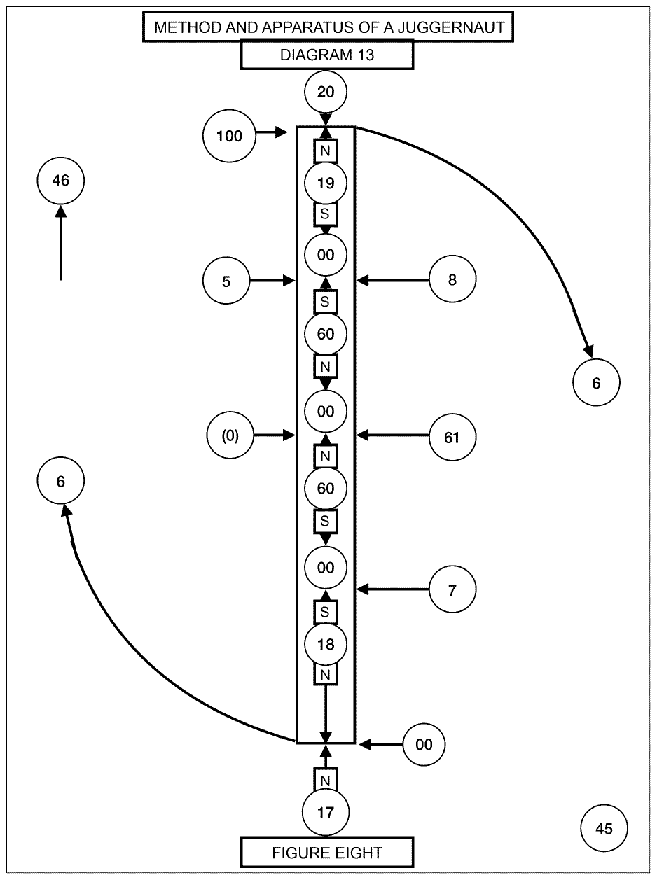

FIG. 8: illustrates a series of magnets including the tertiary magnet (19), quaternary magnet (18), and the primary series of magnets (60) enclosed within a conduit (61) coupled to the beam (5) moreover the mass of matter is intrinsic in the magnets and or beam (5) wherein the magnets are coupled via cascade by the force of magnetic repulsion (00). Diagram 13 illustrates the example from figure one diagram 3 wherein additionally denoted is a conduit (61), coupled to the fulcrum (0) or crankshaft, enclosing a primary series magnets (60), a quaternary magnet (18) and a tertiary magnet (19) configured with the equivalent or like magnetic poles facing each magnet element before and or after in the primary series of magnets wherein the displacement of the magnets are coupled by the force of magnetic repulsion (00). The rotational motion (6) momentum or inertia derived from the sum of the torque produced by the numerous unbalanced beams (5) coupled to the crankshaft (0), as illustrated in figure three diagram 6, impels the quaternary magnet (18) and after rotating 180 degrees the tertiary magnet (19) to rotate into the force of repulsion (00) when in proximity to the secondary magnet (17) wherein producing a chain reaction of the magnetic force of repulsion (00) between the primary series of magnets producing their subsequent displacement in the direction opposite the source of the force of gravity from a nadir position to an acme position producing an increase in potential energy of the mass of matter coupled to the beam (5). The increase in potential energy of the conduit coupled to the beam is converted to kinetic energy by the inertia momentum of the crankshaft coupled to numerous beams (5) comprising kinetic energy momentum or inertia of the numerous beams. An alternate means of function comprises but is not limited to the force of attraction (100) between the primary magnet (20) and the tertiary magnet (19) and or the quaternary magnet (18); moreover the tertiary magnet (19) and or the quaternary magnet (18) may comprise a ferrous material; ever moreover the primary magnet (20) may comprise a ferrous material. The chain reaction may also comprise utilizing both the magnetic force of repulsion (00) and the magnetic force of attraction (100) by means of like magnetic poles, opposite magnetic poles and or the attraction by means of a magnet and a ferrous material. This example contracts the previous examples by means of utilizing magnetic force of repulsion to produce frictionless displacement of the mass of matter verses utilizing a contact force via coupling to a beam and or coupling via a fluid medium within a linear actuator and or a cylinder rod.

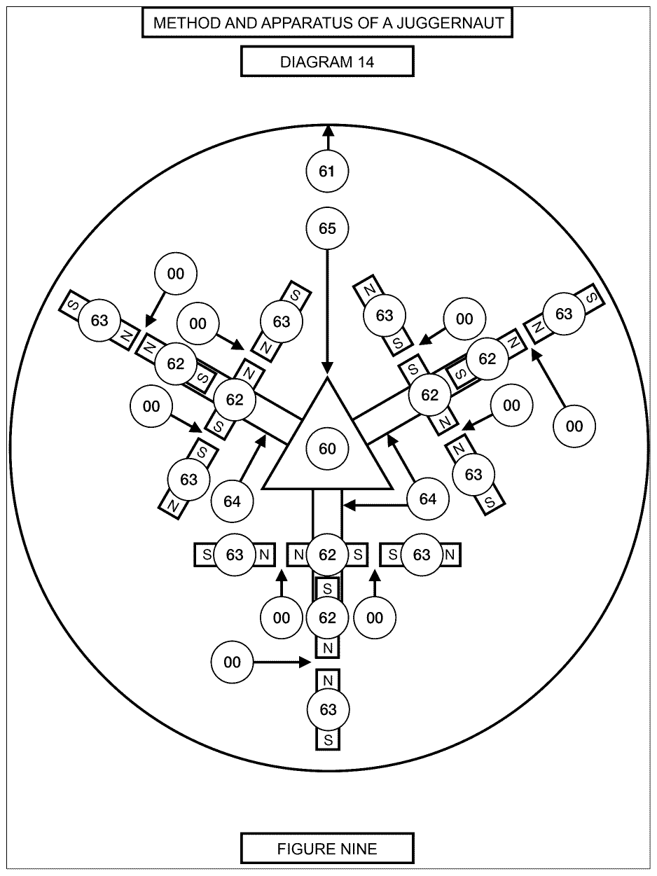

FIG. 9 is one of the central primary series of magnets magnets (60) illustrated in figure eight which are enclosed in a conduit (61); wherein a stabilizing triangulation configuration of a secondary series of magnets (62) fixed to the central magnet (60) via a stabilizing apparatus (65) with an armature (64) produces the magnetic force of repulsion (00) against an anchoring tertiary series of magnets (63) fixed to the conduit (61) producing the frictionless movement of the apparatus (65) comprising the central primary series of magnets (60) within the conduit (61). Utilizing a vacuum within the conduit and the frictionless movement of the primary series of magnets produces the estimated loss due to non-conservative energy to the equivalent of naught and or negligible naught.

Displacement of the masses of matter is impelled, by means of the rotational motion (6) momentum or inertia derived from the sum of the torque produced by the numerous unbalanced beams (5) coupled to the crankshaft (0), as illustrated in figure three diagram 6, wherein the displacement of the mass of matter from a configuration with less potential energy to a configuration with greater potential energy is produced by the means comprising: the repulsion force between a coupled series of magnets, the attraction force of at least two magnets, the attraction force between at least one magnet and at least one ferrous material, the direct contact between a cam on a camshaft and a rocker with lifting rod coupled to the beam, a non contact force from the repulsion force between the like magnetic poles of a magnet on a cam and another magnet on a rocker arm, a spring mounted between a magnet and the beam wherein compressed by the repulsion force between the like poles of at least two magnets, a form of mechanical energy conversion and any combination thereof.

Tandem coupling of the mass of matter produces the ability to balance and unbalance the beam. The tandem coupling of the mass of matter is produced by numerous means comprising: at least two linear actuators coupled by a fluid medium, a solid beam wherein mass is inherit in the beam, at least two masses of matter coupled by a mechanical means such as a lifting rod, a camshaft coupled to rocker arms, two masses of matter coupled by a belt and pulley system, two masses of matter coupled by a chain and sprocket system, two masses of matter coupled by a gear and track system, a series of magnets encased within a conduit with like magnetic poles facing the element before and after in the series coupled by the magnetic force of repulsion, and any combination thereof.

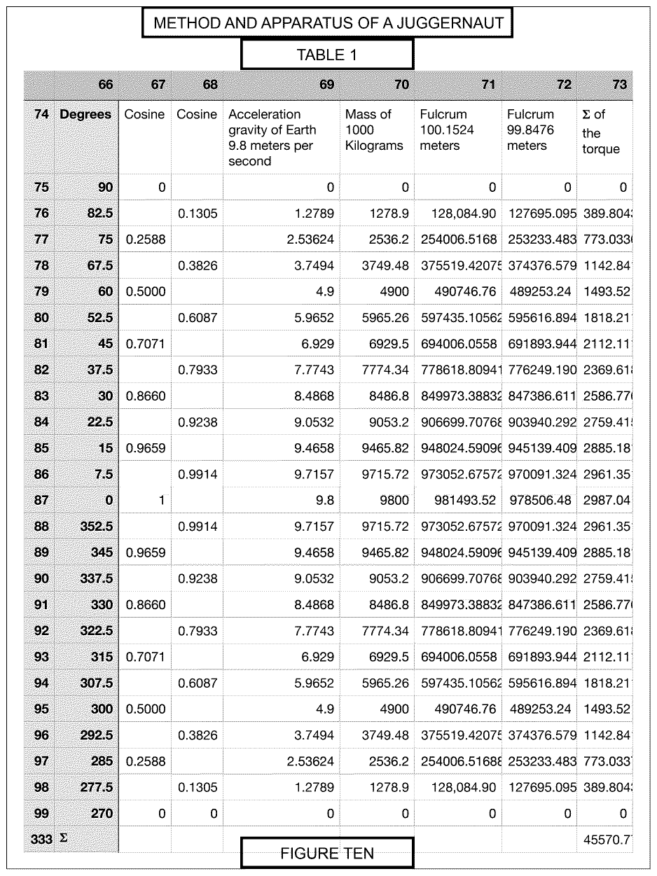

FIG. 10: table one illustrates, utilizing mathematics and physics calculations, the sum of the torque produced by all the beams (5) coupled on the crankshaft (0). Torque(τ) is denoted by the formula τ=r*F where r is the distance from the fulcrum to the application of the force on the structure and F is the force applied perpendicular to the line from the fulcrum to where the force is applied like a lever. The sum of the torque produced by all the beams (5) coupled on the crankshaft (0) wherein the example illustrated in figure nine utilizes a total of 24 beams (5) coupled to the crankshaft (0); moreover each beam is coupled to a mass of matter equivalent to 1000 kilograms on each side of the fulcrum, thus 2000 kilograms per beam (5). The angle between each beam is equidistant from the beam (5) before and after in the series of beams coupled to the crankshaft (5) and in the example illustrated in table one the equidistant angle in degrees between each beam is 7.5 degrees. The displacement of the primary mass of matter (1) coupled in tandem the secondary mass of matter (2) for a distance of displacement (000) equivalent in this example to 0.3 meters as evidenced by senary column (71) primary row (75) data value of 100.1524 meters minus septenary column (72) primary row (75) data value of 99.8476 meters. The primary row (74) is the associated label for each column in the table. The primary column (66) labeled degrees in the primary row (74) illustrates the different degrees of timing in rotational motion of each beam coupled to the crankshaft (0). The secondary column (67) and tertiary column (68) illustrates the calculation of the cosine of the associated degree of angle for its respective beam (5) in the primary column (66); decenary row (83) illustrates the data associated with figure two diagram 4 wherein the degree of angle (9) is 30 degrees thus secondary column (67) decenary row (83) is equivalent to the cosine of a 30 degree angle equaling 0.8660. The data of the quaternary column (69) is the associated cosine value of the row multiplied by the acceleration of gravity on Earth equivalent to 9.8 meters per second; thus for the decenary row (83) the value is 0.866 multiplied by 9.8 equals 8.4868 meters per second. The data of the quinary column (70) is the mass of 1000 kg multiplied by the data of the quaternary column (69) thus for the decenary row (83) 8.4868 meters per second multiplied by 1000 kilograms equals 8,486.8 newtons. The data of the senary column (71) is the secondary mass of matter (2) at a secondary distance (8) of 100.1524 meters away from the fulcrum or crankshaft (0); thus for the decenary row (83) the force of 8,486.8 newtons applied at 100.1524 meters from the fulcrum or crankshaft (0) produces the force of torque (10) of 849,973.38 newton meters. The data of the septenary column (72) is the primary mass of matter (1) at a primary distance (7) of 99.8476 meters away from the fulcrum or crankshaft (0); thus for the decenary row (83) the force of 8,486.8 newtons applied at 99.8476 meters from the fulcrum or crankshaft (0) produces the force of torque of 849,973.38 newton meters. The data of the octonary column (73) equals the sum of torque for the beam (5) at the angle (9) in degrees within the respective primary column (66) wherein equivalent to the data in the senary column (71) minus the data in the septenary column (72); thus for the decenary row (83) 849973.39 newton meters minus 847386.61 newton meters equals 2586.77 newton meters. The data of the octonary column (73) and the twenty-seventh row (333) is the sum of torque of all the 24 beams (5) coupled to the crankshaft (0) equivalent to the sum of all the values in the octonary column (73) equal to 45,570.7 newton meters. From this calculation the work acting on a fulcrum (0) or crankshaft is 45,570.7 N m multiplied by 6.2831 radians (360 degrees) which equals 286,329.1526 joules.

The work required for the displacement of the primary mass of matter (1) at 1000 kg and the secondary mass of matter (2) at 1000 kg coupled to the beam (5) about the fulcrum (0) by a distance of displacement (000) of 0.3 meters in the direction (46) is equal to 2000 kg*9.8 m/s*0.3 m=5,880 joules. In one complete revolution the number of times the mass of matter will undergo displacement in this example is 48 thus 5,880 joules times 48 is equal to 282,240 joules. The work of the sum of the torque (333) of 24 beams with a primary mass of matter (1) at 1000 kg and 100.1524 meters from the fulcrum and a secondary mass of matter (2) at 1000 kg and 99.8476 meters from the fulcrum is equal to (333) 45,570 N m*6.28 radians=286,329 joules. The difference of the work of the displacement of the mass of matter on an individual beam and the sum of the work of the torque from all of the beams coupled to the crankshaft is equal to 286,329 joules minus 282,240 joules which equals 4,089 joules thus producing rotation of the crankshaft and the displacement of each beam when nearly vertical when pushed or impelled by the momentum of said crankshaft into the repulsion force of a magnetic field in the direction opposite the force of gravity.

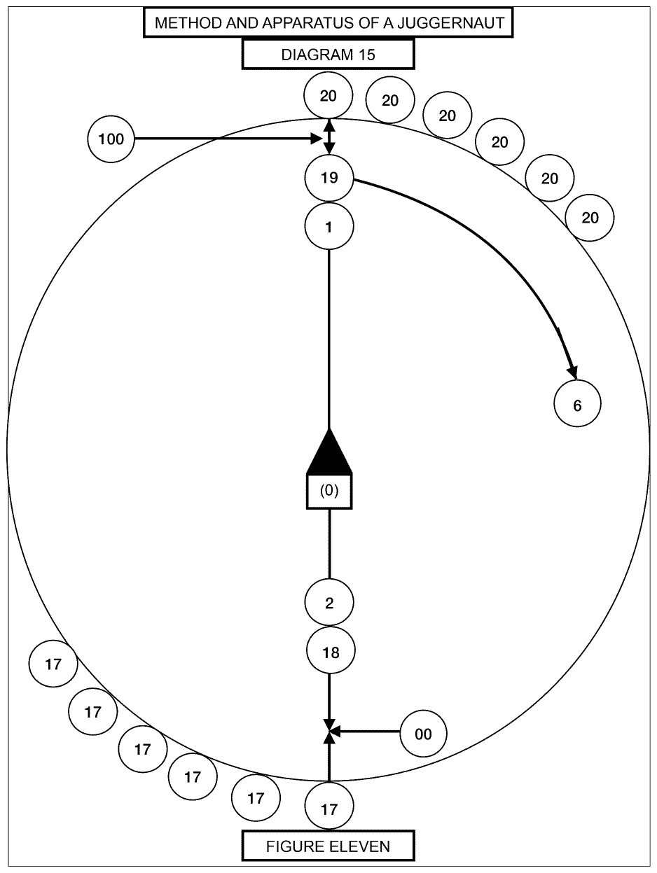

FIG. 11 illustrates the locking mechanism whereby the displacement of the primary series of magnets is frictionless wherein a lock via the magnetic force of repulsion (00), illustrated between quaternary magnet (18) and secondary magnet (17), and or the magnetic force of attraction (00), illustrated between tertiary magnet (19) and primary magnet (20) and or ferrous material (20), holds the beam (5) and the tandem coupling of the primary mass of matter (1) and the secondary mass of matter (2) into the acme position, as illustrated in figure five diagram 9, while rotating about the fulcrum (0) until the process repeats in the nadir position.

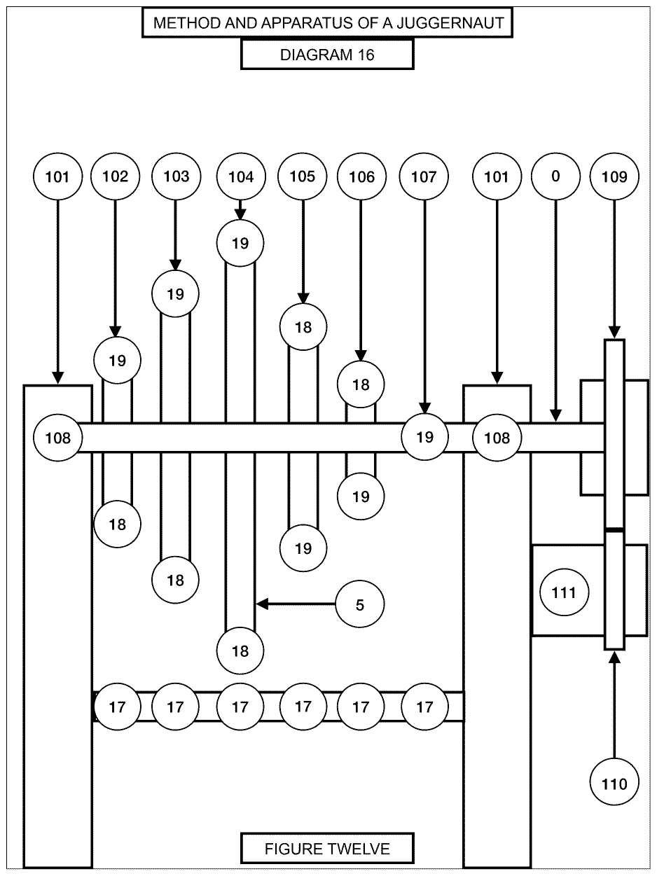

FIG. 12 illustrates a linear crankshaft comprising an alternate to the ferris wheel structure when the displacement of the primary series of magnets is frictionless. A mount (101) houses the crankshaft (0) within a frictionless magnetic bearing (108) coupled to a gear (109) coupled to a transmission (110) and converting the rotational motion of the crankshaft (0) into electricity via an electric generator (111) and or a service and or good. The crankshaft (0) is coupled to numerous beams (5) oriented to different degrees in timing, for example beam (5) (104) is at 90 degrees, beam (5) (107) is at 0 degrees, beam (5) (106) is at 18 degrees, beam (5) (105) is at 54 degrees, beam (5) (103) is at 72 degrees, beam (5) (102) is at 36 degrees.

Best use: figure one diagram 3 is an unbalanced beam (5) coupled to the fulcrum (0) comprising a primary mass of matter (1) equal in mass to a secondary mass of matter (2) wherein the distance (7) from the primary mass of matter (1) to the fulcrum (0) contrasts an unequal distance (8) from the secondary mass of matter (2) to the fulcrum (0) producing torque from the longer lever coupled to the secondary mass of matter (2) on the fulcrum (0) in the direction (6) towards the source of gravity. FIG. 3 diagram 6 illustrates numerous beams (5) coupled to a crankshaft (0) wherein the structure and or frame (45) is synonymous with a ferris wheel structure (21). Figure five diagram 8 and diagram 9 illustrate the displacement of an individual beam from the nadir position in diagram 8 to the acme position in diagram 9; moreover wherein the means of displacement of the tandem mass of matter coupled to the beam (5) and the crankshaft (0), comprising the primary mass of matter (1) coupled to the secondary mass of matter (2), for a distance of displacement (000), in the direction opposite the source of the force of gravity whereby produced by means of the rotational motion (6) momentum or inertia derived from the sum of the torque produced by the numerous unbalanced beams (5) coupled to the crankshaft (0), illustrated in FIG. 3 diagram 6 rotating in the direction (6), impelling the interaction of the magnetic force of repulsion (00) via like magnetic poles between the secondary magnet (17) and the quaternary magnet (18) when in proximity; and then after the crankshaft rotates 180 degrees the above process repeats utilizing the secondary magnet (17) and the tertiary magnet (19). The work required for the displacement, for a distance of displacement (000), in the direction opposite the source of the force of gravity of the tandem mass of matter coupled to the beam (5) and the crankshaft (0), comprising the primary mass of matter (1) coupled to the secondary mass of matter (2), is less than the work of the sum of the torque produced by all the numerous beams (5) coupled to the crankshaft (3). Figure four diagram 7 illustrates the force of repulsion (00) of a union of magnets (47) with their magnetic south poles oriented facing away from the source of the force of gravity and in a lay out of a stepwise series configuration and coupled to the frame (45) and represented as a whole as the secondary magnet (17) wherein producing the force of repulsion (00) for the means to displace the composite structure (22) in the direction (46) nearly opposite the source of the force of gravity. Figure eight diagram 13 illustrates the example from figure one diagram 3 wherein additionally denoted is a conduit (61), coupled to the fulcrum (0) or crankshaft, enclosing a tandem mass of matter comprising the primary series magnets (60), a quaternary magnet (18) and a tertiary magnet (19) configured with the equivalent or like magnetic poles facing each magnet element before and or after in the primary series of magnets wherein the displacement of the magnets are coupled by the magnetic force of repulsion (00) and the displacement is frictionless. The potential energy of the mass of matter coupled to the beam in the acme position is converted into kinetic energy by the rotational motion (6) inertia or momentum of the crankshaft coupled to the beams (5). Figure nine diagram 14 illustrates a stabilizing triangulation configuration of a secondary series of magnets (62) fixed to the central magnet (60) via a stabilizing apparatus (65) with an armature (64) produces the magnetic force of repulsion (00) against an anchoring tertiary series of magnets (63) fixed to the conduit (61) producing the frictionless movement of the apparatus (65) comprising the central primary series of magnets (60) within the conduit (61). Utilizing a vacuum within the conduit and the frictionless movement of the primary series of magnets produces the estimated loss due to non-conservative energy to the equivalent of naught and or negligible naught. A percentage of the magnitude of work remaining from the difference of the work of torque on the crankshaft minus the work required to lift the mass of matter on each individual beam is utilized to produce a good and or a service comprising electricity.

### SEQUENCE LISTING

NA

1. A method and apparatus of a juggernaut comprising:
utilizing a power produced from a apparatus comprising a crankshaft coupled to a series of a beam wherein each said beam comprising a mass of matter;
configuring said series of beams at different degrees of timing in rotational motion;
producing a linear displacement of the coupled said mass of matter along each said beam, when nearly vertical, in the direction opposite the force of gravity wherein the displacement of said mass of matter starting from a position with a less amount of a potential energy and ending at a position with a greater amount of said potential energy;
producing said linear displacement of the coupled said mass of matter by means of the rotational motion momentum of said crankshaft, coupled to said beams and said mass of matter, impelling the interaction of a force, comprising electromagnetic fields, between a primary source of said force coupled to said apparatus and or a secondary source of said force coupled to each said beam; and
forevermore a percentage of said power derived from the rotational motion of said crankshaft is utilized to produce a good and or a service, comprising electricity.

2. The method and apparatus of a juggernaut of claim 1, further comprising:
coupling a conduit to said beam wherein said conduit has a cap and base to retain the contents within said conduit;
designating said beam comprising a primary series of magnets confined within said conduit wherein said mass of matter is inherit and or coupled to said primary series of magnets and the movement of said primary series of said magnets within said conduit is frictionless and each said magnet in said primary series of magnets repels away from the said magnet prior to and or after in said primary series of magnets if applicable;
coupling a secondary series of magnets via a secondary apparatus coupled to said primary series of magnets;
coupling a tertiary series of magnets to said conduit;
denoting the ability of frictionless movement of the primary series of magnets is accomplished by means of said secondary series of magnets fixed to said secondary apparatus producing the force of repulsion between the said secondary series of magnets and the said tertiary series of magnets coupled to said conduit.

3. The method and apparatus of a juggernaut of claim 1, further comprising:
replacing the lexicon “nearly vertical” comprising any position above level.

4. The method and apparatus of a juggernaut of claim 2, further comprising:
replacing the lexicon “nearly vertical” comprising any position above level.

5. A method and apparatus of a juggernaut comprising:
designating a fulcrum being synonymous with a crankshaft;
coupling said crankshaft to a frame;
producing torque on said crankshaft causing rotation of said crankshaft by means of at least one of a beam comprising a potential energy wherein each said beam coupling to a mass of matter positioned on said beam in an unbalanced manner with said potential energy about said fulcrum;
optioning said mass of matter positioning on said beam in an unbalanced manner as either comprising:
positioning the unbalanced mass of matter on the right hand side of the vertical axis of said crankshaft when said crankshaft is rotating clockwise; or
positioning the unbalanced mass of matter on the left hand side of the vertical axis of said crankshaft when said crankshaft is rotating counterclockwise; and
wherein converting said potential energy to kinetic energy;
wherein when each individual said beam rotates to nearly vertical with gravity then the unbalanced said mass of matter undergoing displacement in the direction opposite the force of gravity from a nadir position to an acme position for a specific magnitude by means of a force applied to said mass of matter in a direction opposite the force of gravity;
wherein said force comprising a contact and or a non contact force comprising a non contact force produced by the repulsion between a magnet coupled to said frame and or apparatus and a magnet coupled to each individual said beam;
optioning to add a force applied opposite the force of gravity to said mass of matter comprising a non contact force produced from the attraction between a magnet coupled to said frame and a magnet coupled to each individual said beam and or a ferrous material;
wherein the magnitude of work from the sum of the torque of the numerous said beams coupled to said crankshaft is greater than the magnitude of work required for the displacement of each said mass of matter coupled to each individual said beam in the direction opposite the force of gravity; and
producing a good and or a service utilizing a percentage of the magnitude of power remaining from the difference of the work of torque of all said beam coupled to said crankshaft minus the work required for the displacement of said mass of matter on each individual said beam.

6. The method and apparatus of a juggernaut of claim 5, further comprising:
replacing the lexicon “nearly vertical” comprising any position above level.

7. A method and apparatus of a juggernaut comprising:
providing:
a mass of matter;
a primary mass of matter;
a secondary mass of matter;
a tandem mass of matter;
a frame;
a conduit;
a crankshaft;
a primary beam;
a secondary beam;
a case;
a magnet;
a camshaft;
a linear actuator;
a fluid medium;
a ferrous material;
a gear;
a track;
a pulley;
a belt;
a sprocket;
a chain;
a bearing;
a primary brake;
a secondary brake; and
a sensor;
coupling said frame to said bearing;
coupling said bearing to said crankshaft;
coupling said primary brake to said frame and said crankshaft;
coupling said sensor to each individual said beam;
concatenating said crankshaft, said gear, and said transmission with a powertrain and or said electric generator producing a good and or a service comprising electricity when said crankshaft rotates in rotational motion;
denoting a primary replication point;
providing said beam;
coupling said beam to said crankshaft;
denoting a primary insertion point;
coupling said beam to said mass of matter;
optioning to uncouple said beam from said crankshaft as needed;
releasing said primary brake;
rotating said crankshaft;
engaging said primary brake stopping said crankshaft;
inserting into a secondary replication point;
inserting into a tertiary replication point;
repeating any action in any order as needed;
repeating from said primary replication point until the desired amount of said beam are coupled to said crankshaft;
denoting said secondary replication point;
providing a primary means to couple said mass of matter in a tandem configuration;
selecting options of said primary means of tandem comprising:
at least one said linear actuator coupled by said fluid medium to at least one additional said linear actuator;
at least one said secondary beam couples to said primary beam wherein displacing along a track;
at least one element, being a said magnet, of a series configured with its magnetic poles to produce the force of repulsion from each element before and after in said series wherein said series being contained within a conduit and the movement of said element is frictionless;
at least one said pulley coupled to said belt coupling said primary mass of matter to said secondary mass of matter;
at least one said chain coupled to said sprocket coupling said primary mass of matter to said secondary mass of matter; or at least one said gear coupled to said track coupling said primary mass of matter to said secondary mass of matter;
repeating from said secondary replication point until the desired amount of said tandem configuration by way of said primary means are coupled to said beam;
inserting into said primary replication point;
denoting said tertiary replication point;
providing a secondary means of force producing a force for displacement of said mass of matter in a direction opposite the force of gravity while said beam is nearly vertical;
selecting said secondary means to displace said mass of matter comprising:
at least one of a primary said magnet coupled to said beam with its magnetic pole configured to produce a force of repulsion in a direction opposite the force of gravity producing displacement away from at least one of a secondary said magnet coupled to said frame when said primary said magnet and said secondary said magnet are within proximity;
at least one of a primary said magnet coupled to said beam with its magnetic pole configured to produce a force of attraction in a direction opposite the force of gravity producing displacement towards at least one said secondary said magnet coupled to said frame when said primary said magnet and said secondary said magnet are within proximity;
at least one said primary said magnet coupled to said beam with its magnetic pole configured to produce a force of repulsion in a direction opposite the force of gravity producing displacement away from at least one of a tertiary said magnet coupled to said frame and at least one said primary said magnet coupled to said beam with its magnetic pole configured to produce a force of attraction in a direction opposite the force of gravity producing displacement towards at least one said secondary said magnet coupled to said frame when said primary said magnet, said secondary said magnet, and said tertiary said magnet are within proximity;
at least one said ferrous material coupled to said beam to produce a force of attraction in a direction opposite the force of gravity towards at least one said secondary said magnet coupled to said frame when aligned nearly vertical when said primary said magnet and said secondary said magnet are within proximity;
at least one said primary said magnet is coupled to said beam with its magnetic pole configured to produce a force of attraction in a direction opposite the force of gravity towards at least one ferrous material coupled to said frame; and
at least one said camshaft coupled to said crankshaft producing displacement of said mass of matter via a cam on said camshaft utilizing a contact and or non contact force wherein the non contact force comprises utilizing the repulsion force of magnetism;
repeating from said tertiary replication point until the desired secondary means for displacement of said mass of matter while said beam is nearly vertical are selected;
inserting into said primary replication point;
denoting a quaternary replication point;
operating said crankshaft by releasing said primary brake;
sensing by said sensor on each said beam for a tertiary means to determine when each beam is nearly vertical and then releasing a secondary brake to release said mass of matter wherein the mass of matter sustains displacement in a direction opposite the force of gravity from a nadir position with less of a potential energy to an acme position with greater of said potential energy by said secondary means;
engaging said secondary brake locking said mass of matter in said acme position on each individual said beam;
converting said potential energy of the unbalanced said mass of matter to a kinetic energy by means of a rotational motion of said crankshaft;
utilizing the rotational motion or kinetic energy of said crankshaft to produce said good and or said service comprising electricity;
optioning to inserting into said primary replication point; and
repeating from said quaternary replication point until mechanical failure and or to produce the reduction and or ceasing the rotation of said crankshaft.

8. The method and apparatus of a juggernaut of claim 7, further comprising:
replacing the lexicon “nearly vertical” comprising any position above level.

9. A method and apparatus of a juggernaut comprising:
providing:
a gravitational force;
a normal force;
a vacuum;
a primary mass;
a secondary mass;
a beam;
a primary magnet
a secondary magnet;
a tertiary magnet;
a quaternary magnet;
a quinary magnet;
a senary magnet;
a septenary magnet;
a octonary magnet;
a prime linear actuator;
a sub-prime linear actuator;
an intermediate prime linear actuator;
an intermediate ultimate linear actuator;
a sub-ultimate linear actuator;
an ultimate linear actuator;
a primary tube;
a secondary tube;
a tertiary tube;
a valve;
a series;
an element;
a foundation;
a frame;
a case;
a bearing;
a lubricant;
a keeper;
a crankshaft;
a coupler;
a primary brake;
a secondary brake;
a sensor;
a switch;
a gear;
a transmission;
an electric generator;
a good; and
a service;
orienting to a euclidian space with an x-axis, a y-axis, and a z-axis;
building said foundation;
mounting said frame to said foundation;
mounting said bearing and said keeper to said frame;
situating the length of said crankshaft to said x-axis;
securing said crankshaft to said frame within said bearing and containing within said keeper;
applying said lubricant to said bearing unless said bearing is magnetic;
centering said crankshaft at the intersection of the z-axis and the y-axis;
rotating said crankshaft in said z-axis;
securing and engaging said primary brake to said crankshaft and said frame;
coupling said crankshaft to said beam in the position plumb to said gravitational force in said z-axis wherein the center of said beam runs through the center of said crankshaft;
coupling said prime linear actuator on the end of said beam in the positive z-axis wherein the cylinder rod of said prime linear actuator extends away from said crankshaft and retracts toward said crankshaft;
coupling said primary mass to said prime linear actuator;
coupling said tertiary magnet to said primary mass wherein the magnetic north pole is facing away from said crankshaft;
coupling said sub-prime linear actuator to said beam and said prime linear actuator aligning base to base wherein said sub-prime linear actuator extends towards said crankshaft and retracts away from said crankshaft;
coupling said quinary magnet to the cap of said sub-prime linear actuator cylinder rod wherein the magnetic north pole is facing towards the crankshaft;
coupling said primary tube from said prime linear actuator to said sub prime linear actuator wherein when said prime linear actuator cylinder rod retracts then said fluid medium flows into said sub-prime linear actuator causing said sub-prime linear actuator cylinder rod to extend and vice versa;
coupling said ultimate linear actuator on the end of said beam in the negative z-axis wherein the cylinder rod of said ultimate linear actuator extends away from said crankshaft and retracts toward said crankshaft;
coupling said secondary mass to said ultimate linear actuator;
coupling said quaternary magnet to said secondary mass wherein the magnetic north pole is facing away from said crankshaft;
coupling said sub-ultimate linear actuator to said beam and to said ultimate linear actuator aligning base to base wherein said sub-ultimate linear actuator extends towards said crankshaft and retracts away from said crankshaft;
coupling said octonary magnet to the cap of said sub-ultimate linear actuator cylinder rod wherein the magnetic north pole is facing towards the crankshaft;
coupling said tertiary tube from said ultimate linear actuator to said sub-ultimate linear actuator wherein when said ultimate linear actuator cylinder rod retracts then said fluid medium flows into said sub-ultimate linear actuator causing said sub-ultimate linear actuator cylinder rod to extend and vice versa;
coupling said intermediate prime linear actuator to said beam in-between said sub-prime linear actuator and said crankshaft wherein said intermediate prime linear actuator cylinder rod extends away from said crankshaft and retracts towards said crankshaft;
coupling said intermediate ultimate linear actuator to said beam in between said sub-ultimate linear actuator and said crankshaft wherein said intermediate ultimate linear actuator cylinder rod extends away from said crankshaft and retracts towards said crankshaft;
coupling said secondary tube from said intermediate prime linear actuator to said intermediate ultimate linear actuator wherein when said intermediate prime linear actuator cylinder rod retracts then said fluid medium flows into said intermediate ultimate linear actuator causing said intermediate ultimate linear actuator cylinder rod to extend and vice versa;
coupling said senary magnet to the cap of said intermediate prime linear actuator cylinder rod wherein the magnetic north pole is facing away from said crankshaft;
coupling said septenary magnet to the cap of said intermediate ultimate linear actuator cylinder rod wherein the magnetic north pole is facing away from said crankshaft;
coupling said secondary magnet to said frame directly plumb underneath said crankshaft wherein the magnetic north pole is facing towards the crankshaft moreover with enough clearance for said tertiary magnet and said quaternary magnet to not make physical contact however close enough for the magnetic fields to produce a repulsion force while in proximity;
coupling said secondary brake to said primary mass and said secondary mass wherein said secondary brake comprises said valve coupled to said primary tube, said secondary tube, and or said tertiary tube;
attaching a said sensor to each said beam;
detecting by said sensor when each said beam is nearly vertical opening a switch or valve to release said secondary brake;
detecting by said sensor when said beam is rotating past vertical then closing said switch or valve to apply said secondary brake;
creating an element of a series comprising the aforementioned configurations on said beam wherein when the cylinder rod of said prime linear actuator is retracted along with said primary mass producing a chain reaction between the linear actuators causing the cylinder rod of said ultimate linear actuator to extend along with said secondary mass and vice versa;
releasing said primary brake producing torque to said crankshaft causing rotational motion of said crankshaft until said beam is vertical to said gravitational force and the z-axis while simultaneously releasing said secondary brake wherein the magnetic pole of said secondary magnet produced the force of repulsion and displacement in the direction opposite the force of gravity of said tertiary magnet causing the cylinder rod of said prime linear actuator to retract along with said primary mass then a chain reaction causes the cylinder rod of said ultimate linear actuator to extend along with said secondary mass;
wherein producing a linear displacement of the coupled said mass of matter along each said beam, when nearly vertical, in the direction opposite the force of gravity wherein the displacement of said mass of matter starting from a position with a less amount of a potential energy and ending at a position with a greater amount of said potential energy;
locking said secondary brake;
converting said potential energy of the unbalanced said mass of matter to a kinetic energy by means of a rotational motion of said crankshaft;
optioning to include the force of attraction between said primary magnet and said tertiary magnet and said quaternary magnet;
optioning for said primary magnet to be a ferrous material;
duplicating said element;
releasing said primary brake and rotating said crankshaft a desired degree of rotation;
duplicating said element numerous times to produce said series;
coupling the duplicated said series in the position horizontal or plumb to said gravitational force in the z-axis to said crankshaft wherein whenever a duplicated said series is coupled to said crankshaft the intersecting angle between each individual said series is equal;
optioning to coupling said primary magnet to said frame above said crankshaft wherein the magnetic south pole is facing towards the crankshaft moreover with enough clearance for said tertiary magnet and said quaternary magnet to not make physical contact however close enough for the magnetic fields to produce the force of attraction when in proximity;
optioning to reverse the orientation of all the magnetic poles on each said magnet synchronously as needed;
optioning for said secondary magnet comprising a union of numerous said magnets oriented in a sloping fashion providing a gradual non contact force of repulsion between said secondary magnet and either said tertiary magnet and or said quaternary magnet;
optioning for producing said vacuum in said case and or filling said case with a fluid medium comprising helium;
concatenating said crankshaft, said gear, and said transmission with a powertrain and or said electric generator producing a good and or a service comprising electricity when said crankshaft rotates;
operating said crankshaft by releasing said primary brake and utilizing the rotational motion of said crankshaft to produce said good and or said service; and
repeating any of an action as needed in any order.

10. The method and apparatus of a juggernaut of claim 9, further comprising:
replacing the lexicon “nearly vertical” comprising any position above level.
